(19) United States
(12) Patent Application Publication
(10) Pub. No.: US 2006/0183501 A1
(43) Pub. Date: Aug. 17, 2006

(54) Expansion module system and control method therefor

(76) Inventors: Yasuo Egoshi, Zama (JP); Norio Kitagata, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/345,371

(22) Filed: Feb. 2, 2006

(30) Foreign Application Priority Data
Feb. 3, 2005 (JP) 2005-027153

(51) Int. Cl. H04B 1/38; H04M 1/00

(52) U.S. Cl. 455/558

(57) ABSTRACT

An expansion module has a standard interface, such as USB or a PC card, with its outward shape structured to allow the expansion module to be exclusively used with the drive unit of a recording medium. An information processing system includes a first ID recording unit in which the ID of the information processing system is recorded, a second ID recording unit in which a copy of the ID information in the first ID recording unit is recorded when the expansion module is initialized, an ID comparison unit that compares both ID information when the expansion module is used, and a module control unit that controls whether the expansion module is to be operated, wherein, if the ID information in the first ID recording unit matches the ID information in the second ID recording unit, the expansion module can be used.

### INCORPORATION BY REFERENCE

The present application claims priority from Japanese application JP2005-027153 filed on Feb. 3, 2005 the content of which is hereby incorporated by reference into this application.

### BACKGROUND OF THE INVENTION

Recently, the increased use of PCs as mobile devices and the widespread use of mobile communication are combined to increase the chances of sending and receiving data via mobile communication. To meet this need, a communication carrier that provides the mobile communication service sometimes provides special services integrated with a device or makes the communication module setting easier to build a business model for keeping the users. In this case, a communication carrier usually builds a communication module into a system device such as a PC in advance and sells the communication module and the system device main body as a set. Especially, the communication carrier side desires that the communication module not be used in other devices to increase the number of communication terminals.

On the other hand, to allow a communication module to be used widely as a data communication unit, the development of a communication module with an industry-standard interface function, such as a PC card, is now under way.

JP-A-2004-104393 discloses a technology for preventing the leakage of the connection information on a communication adapter wherein the communication adapter connects a special product, such as a digital camera, to the Internet and records therein the information on the connection to the Internet. JP-A-2004-104393 discloses a technology in which the identification information on a communication device to be connected is registered in the communication adapter and, when the communication device is connected to the communication adapter, the communication adapter checks if the communication device is registered in advance and, only if only the communication device is registered, carries out the communication.

According to the technology disclosed in JP-A-2004-104393, the communication devices to be connected to a communication adapter can be limited. However, the technology does not take into consideration a communication adapter built or installed in an information processing device such as a PC and, therefore, cannot be applied to a PC-standard communication adapter such as a PC card.

In addition, a communication module designed to be built in a system device becomes a communication module specialized for that system device. Because such a communication module cannot be produced in large quantities, the volume efficiency is decreased and the cost is increased.

Another problem is that the system device requires a special area for installing the communication module. This area makes it difficult to make the system device compact and, at the same time, becomes a wasteful space on a model in which the communication module is not installed.

### SUMMARY OF THE INVENTION

It is an object of the present invention to solve the problems described above. More specifically, an object of the present invention is to provide a control method for the integrated operation of a communication module and a system device and thereby to standardize the communication module and to increase the availability of the system device.

To solve the above problem, an information processing system according to the present invention, in which an expansion module, such as a communication module, is built in, comprises a first ID recording unit in which ID information, which identifies the information processing system, is recorded; a second ID recording unit in which a copy of the ID information in the first ID recording unit is recorded when the expansion module is initialized; an ID comparison unit that compares the ID information recorded in the first ID recording unit with the ID information recorded in the second ID recording unit when the expansion module is used; and a module control unit that controls whether the expansion module is to be operated, wherein the module control unit makes the expansion module available for use if the ID information in the first ID recording unit matches the ID information in the second ID recording unit.

An information processing system according to the present invention comprises a base station, which has the second ID recording unit and the ID comparison unit for communicating with the expansion module, and an information processing device which has the first ID recording unit and the module control unit, wherein the information processing device notifies the ID information in the first ID recording unit to the second ID recording unit in the base station when the expansion module is initialized and, when the communication is started, notifies the ID information to the base station and wherein the base station records the ID information in the second ID recording unit for each of the information processing devices and, when the communication with the expansion module is started, uses the ID comparison unit to compare the notified ID information with the ID information recorded in the second ID recording unit and, if a mismatch occurs in the ID information, stops the communication with the expansion module.

The expansion module has a standard interface, such as USB or a PC card, and the outward shape of the expansion module, in which the communication module is built, is structured to allow the expansion module to be exclusively used with the drive unit of a recording medium.

According to the present invention, a system device and an expansion module can be uniquely combined for operation to prevent an illegal use of the expansion module.

In addition, the standardization of an expansion module such as a communication module reduces the cost of the expansion module and increases the availability of a system device that includes the expansion module.

Other objects, features, and advantages of the present invention will become apparent from the following description of the preferred embodiments taken in conjunction with the accompanying drawings.

### BRIEF DESCRIPTION OF THE DRAWINGS

FIG. 1 is a diagram showing the general configuration of a system device of the present invention.

FIG. 2 is a diagram showing the external view of an expansion module.

FIG. 3 is a flowchart showing the operation of an embodiment.

FIG. 4 is a diagram showing the configuration when the operation is controlled in a communication module.

FIG. 5 is a diagram showing the configuration when an interface micro computer of the communication module controls the operation.

FIG. 6 is a diagram showing the configuration when the communication module and the control unit of the module are provided in the expansion unit.

FIG. 7 is a diagram showing the configuration of a system when the communication module is connected to a base station.

FIG. 8 is a flowchart showing how ID information is checked in the base station.

FIG. 9 is a diagram showing the configuration of a system in another embodiment.

### DESCRIPTION OF THE EMBODIMENTS

The present invention relates to an expansion module such as a communication module connected to an external system and to a module configuration and a module control method suitable for an information processing device, such as a PC, in which the expansion module is built.

In the present invention, when an expansion module that includes a communication module is used, the ID information uniquely identifying a system device that uses the expansion module is compared with the ID information identifying the expansion module and, only when the combination is a predetermined combination, the expansion module is made available. The following describes the embodiments each of uses ID information storage means and comparison means that differ from those of the others.

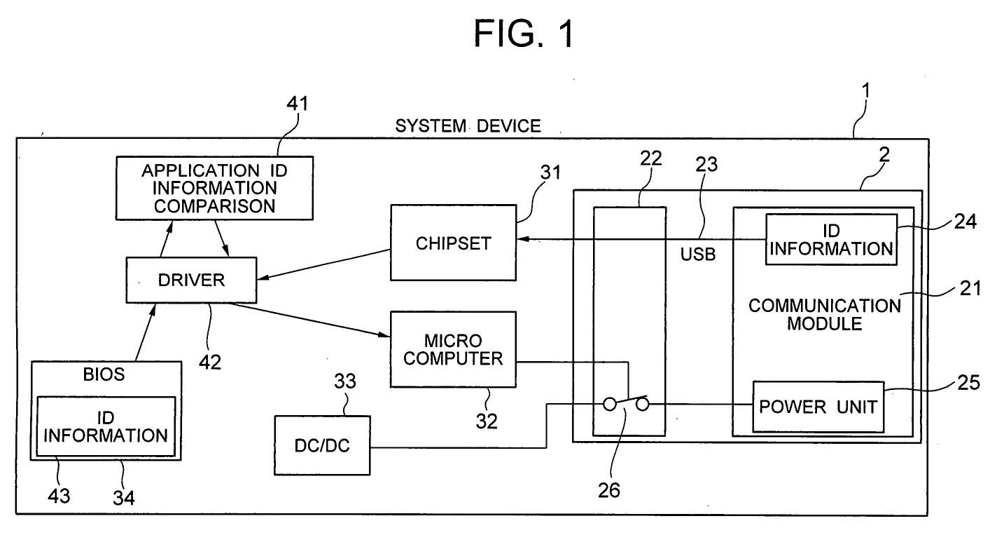

One embodiment of the present invention will be described with reference to FIG. 1 to FIG. 3.

FIG. 1 is a diagram showing the general configuration of the embodiment. A system device 1 includes input units such as a display and a keyboard and a CPU, not shown, and comprises an expansion module 2 that can be inserted into or removed from the system device. An example of the system device 1 with such a configuration is a notebook personal computer.

The system device 1 comprises a chipset 31 that performs the system control of the device, a DC/DC converter 33 that supplies power to the expansion module 2, a micro computer 32 that controls the power of the expansion module 2, a start program of the system device 1, and a BIOS-ROM (34) that stores ID information 43 that will be described later in detail. The system device 1 further comprises programs such as an application program 41 executed by the CPU not shown and a driver 42 that controls the expansion module 2.

The expansion module 2, connected to the chipset 31 via a USB (Universal Serial Bus) interface, operates on the power supplied by the DC/DC converter 33. The expansion module 2, which comprises a communication module 21 and an interface connection unit 22 that controls the connection between the system device 1 and the communication module 21, is connected to the system device 1 via a USB interface 23.

The communication module 21 internally stores ID information 24, which will be described later in detail, and has a power unit 25 that controls the power of the communication module 21. The interface connection unit 22 controls the connection between the system device 2 and the communication module 21 and has a switch 26 that controls the power supplied to the power unit 25. Because the communication module 21 is connected to the chipset 21 via the USB interface in the embodiment shown in FIG. 1, the interface connection unit 22 simply connects the signal line. If the interface voltage of the communication module differs from that of the chipset 21, it is possible for the interface connection unit 22 to convert the voltage level.

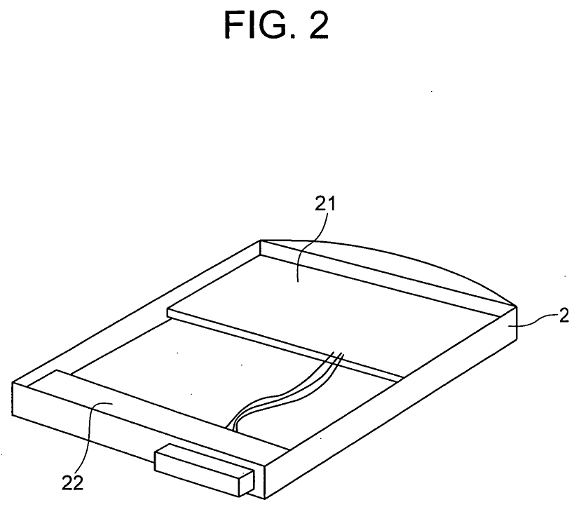

FIG. 2 is a diagram schematically showing the external view of the expansion module 2. The same numerals as those in FIG. 1 are used for the interface connection unit 22 and the communication module 21. Providing the communication module 21 and the interface connection unit 22 in the expansion module 2 in this way allows the expansion module to have the following configuration.

The outward form of a portable information apparatus such as a notebook PC differs according to the models provided by the manufacturers. For this reason, the outward form of the expansion module differs among the manufacturers. Because a built-in communication module is designed conventionally for each module, the development cost is sometimes increased and there are variations in performance and quality. In this embodiment, the outward form of a communication module used commonly by the models is defined, and the communication module 21 is built in the expansion module 2. For example, a wireless LAN module and a mobile communication module are designed to have a size similar to the size of a CF (CompactFlash) card, and this size is defined as the size of a common communication module.

In addition, to ensure the interface compatibility between the communication module and the device main body to which the communication module is connected, the interface connection unit 22 is provided. This interface connection unit further increases the versatility of the communication module and enhances the volume efficiency, achieved by the standardization, to reduce the cost.

The expansion module may also have outside dimensions common to other I/O devices. For example, because a CD-ROM/DVD drive is not always used, the expansion module is designed to have a form to include the CD-ROM/DVD drive so that the communication module in this embodiment can be used exclusively with the CD-ROM/DVD drive. This design has an effect of increasing device availability.

In this case, when the expansion module and the device main body are connected via the USB interface, the interface connection unit 22 of the expansion module that includes the communication module uses a USB direct connection and the interface connection unit 22 of the expansion module that includes a CD-ROM/DVD drive performs the USB/ATA conversion.

When the expansion module and the device main body are connected by a connector compatible with USB and ATA, the interface connection unit 22 of the expansion module that includes the communication module selects the USB interface signal to connect to the communication module.

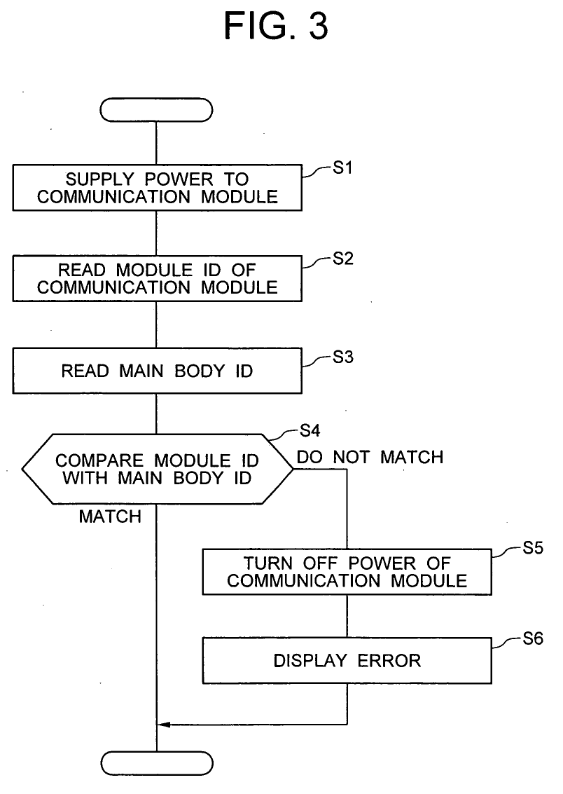

FIG. 3 is a flowchart showing the control operation in this embodiment.

First, the following describes the ID information 43 stored in the BIOS-ROM (34) and the ID information 24 stored in the communication module 21. The ID information 43 and the ID information 24 are ID information for uniquely identifying a combination of the system device 1 and the communication module 21. In general, the system device 1 and the communication module 21 usually have device identification information, such as manufacturing management numbers (serial numbers), for individually identifying the devices and modules, and this information is used as ID information in this embodiment. Referring to FIG. 3, the serial number of the system device is stored in the BIOS-ROM (34) and this number is used as the ID information 43.

In the embodiment shown in FIG. 1, the device identification information stored in the BIOS-ROM (34) is used as the ID information 43. When the communication module is used for the first time, the data of the ID information 43 is recorded into the ID information 24. After the data is recorded, the content of the ID information 24 is protected from being rewritten because the ID information 43 and the ID information 24 are compared to identify the combination of the system device 1 and the communication module 21. To protect the ID information 24 from being rewritten, the write program of the ID information 24 is used to perform the write-once operation. Alternatively, a write-once device may also be used as a memory device in which the ID information 24 is recorded.

The following describes the flowchart in FIG. 3 in detail.

During the startup of the system device 1, the operating system (hereinafter called OS), not shown, instructs the micro computer 32 to supply power to the communication module 21 of the expansion module 2. In response to the instruction to supply power to the communication module 21, the micro computer 32 turns on the switch 26 to supply power from the DC/DC 33 to the power unit 25 (step S1). After issuing the instruction to supply power to the expansion module, the OS checks the type of the expansion module 2 and starts the driver 42 that controls the expansion module.

When an application program (hereinafter called AP) that uses the communication module 21, such as a mail software program, is started, the AP instructs the driver 42 to acquire the ID information on the communication module. The driver 42 acquires the ID information 24, stored in the communication module 21 when it is used for the first time, via the chipset 31 and notifies the acquired ID information 24 to the AP 41 (step S2).

Next, the AP 41 instructs the driver 42 to acquire the ID information on the system device 1. The driver 42 notifies the device identification information, stored in the BIOS-ROM (34), to the AP 41 as the ID information 43 (step S3).

The AP 41 compares the acquired communication module ID information 24 with the device identification ID information 43 and, if they match, continues the operation of the AP (step S4). If they do not match, the AP instructs the micro computer 32 via the driver 42 to stop supplying power to the communication module 21. The micro computer 32 turns off a switch 9 to stop supplying power from the DC/DC 33 to the power unit 25 (step S5).

In addition, the AP 41 displays an error on the display of the system device 1, not shown, to indicate that the communication module cannot be used because of a mismatch in the ID information (step S6).

As described above, the application program that uses the communication module 21 checks the combination of the system device and the communication module. Therefore, if installed in some other system device, the communication module 21 cannot be used by the application program.

Although the ID information on the system device 1 is stored in the BIOS-ROM (34) in the description of FIG. 1 and FIG. 3, the storage is not limited to the BIOS-ROM (34) but a non-volatile memory such as an EEPROM may also be used. The storage may also be the HDD built in the system device.

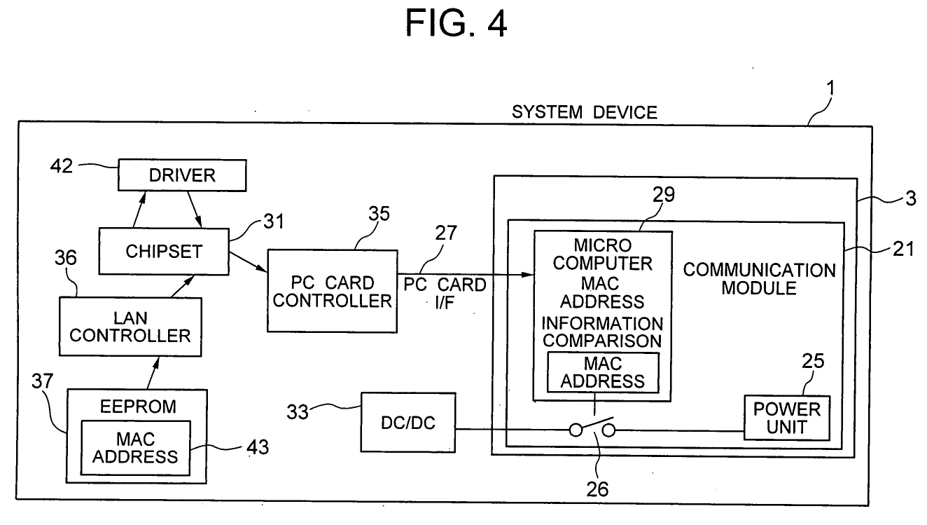

FIG. 4 is a diagram showing the configuration in which an example of another type of ID information different from that in FIG. 1 is used, a method of comparing another type of ID information is employed, and the communication module has a shape of a PC card. Referring to FIG. 4, the communication module 21 is implemented as a PC card 3 and a micro computer 29 built in the communication module 21 compares the ID information.

In the example shown in FIG. 4, the ID information on the system device 1 is a MAC address 43 stored in an EEPROM 37 and used by a LAN controller 36. As in FIG. 1, the ID information (MAC address) 43 is read when the communication module 21 is used for the first time and is registered in the micro computer 29 in the communication module 21 for use as the ID information 24 identifying the system device. To register the ID information, the EEPROM area in the micro computer 29 is used. It is well known that a MAC address is unique among the devices connected to the Ethernet (registered trademark).

When the system device 1 is started or the PC card 3 is inserted, the ID information is detected according to the procedure described below for checking the combination of the system device 1 and the PC card 3.

First, when a PC card controller 35 detects that a PC card 3 is inserted, the driver 42 that controls the PC card is started and, at the same time, the power is supplied from the DC/DC 33 to the power unit 25 via the switch 26. The driver 42, when initially started, reads the MAC address (ID information) 37 recorded in an EEPROM 63 connected to the LAN controller 36 and notifies the ID information, which identifies the system device, to the micro computer 29 in the communication module 21 via the PC card controller 35. The micro computer 29 compares the ID information, registered at the initial startup time, with the ID information notified from the system device 1 and, if they do not match, turns off the switch 26 to stop the supply of power to the power unit 25 of the communication module 21.

As described above, even when the communication module is a standardized PC-card type communication module, a combination of the system device and the communication module can be uniquely identified. Especially, the configuration shown in FIG. 4, in which the present invention can be applied to the firmware of the micro computer 29 in the communication module and to the driver that controls the communication module, achieves a cost-reduction effect. This configuration can be applied also to non-PC-cards such as CF cards and SD cards.

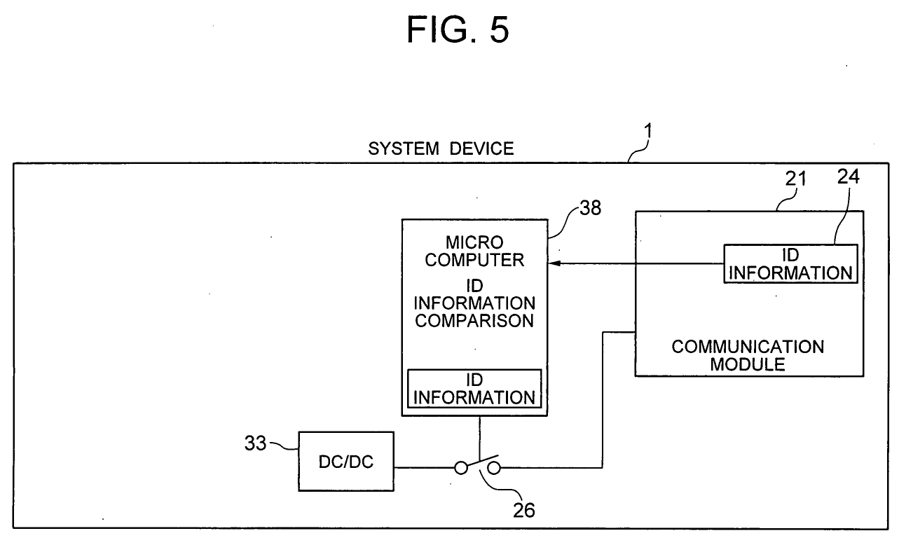

FIG. 5 is a diagram showing the configuration in which the communication module 24 is built in the system device 1. In this example, the ID information matching detection processing described above is included in an interface micro computer 38 that connects the communication module 24 to the system device 1. In this case, ID information 28 identifying the system device is stored in the EEPROM area built in the micro computer 38.

When the system device 1 is started, the micro computer 38 turns on the switch 26 to supply power from the DC/DC 33 to the communication module 21. After that, the micro computer 38 reads the ID information 24 included in the communication module 21 and checks if it matches the ID information 28 stored in the micro computer 38. If the ID information does not match, the micro computer 38 turns off the switch 26 to stop the supply of power to the communication module 21 and stops the interface function of the micro computer 38.

As in other examples, when the communication module 21 is used for the first time, the content of the ID information 28 is stored in the ID information 24. Unlike the other examples, the ID information is a value that is unique among the system devices 1 and is not limited to a MAC address or a manufacturing management number (serial number).

Although the ID information is stored in the micro computer in the configuration shown in FIG. 4 and FIG. 5, it is also possible that a non-volatile memory such as an EEPROM is connected to the micro computer to store the ID information in this memory.

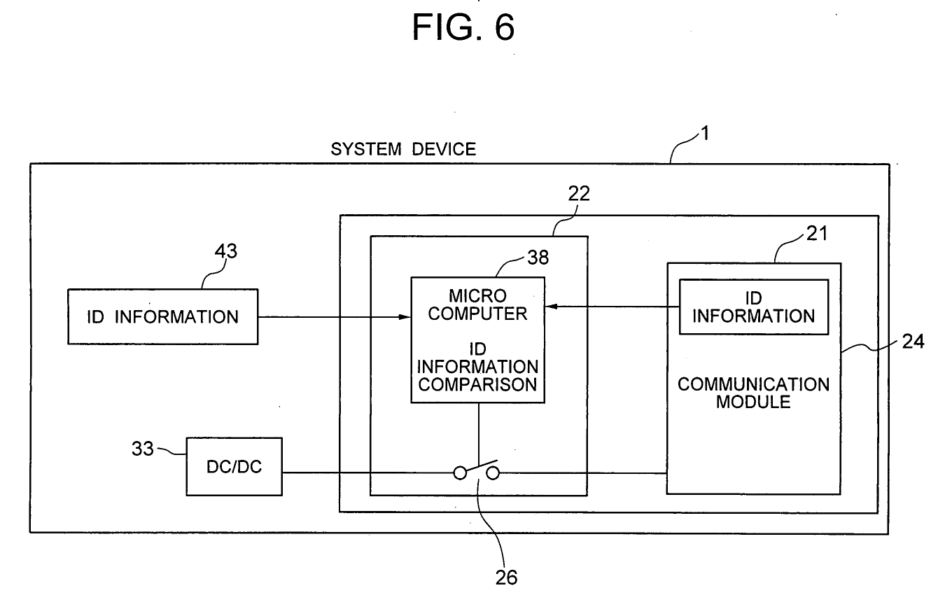

FIG. 6 shows an example of the configuration in which the interface micro computer 38 and the switch 26 in FIG. 5 are integrated into the interface connection unit 22 in FIG. 1 and both the interface connection unit 22 and the communication module 21 are built in the expansion module 2. Unlike the configuration shown in FIG. 1, this configuration allows the communication module 21 to be converted to the standard interface of the system device 1 for use in connection even if the communication module 21 is a specialized interface, thus making the specialized communication module 21 to be generalized. In addition, the standardized expansion module 2 increases the availability of the system device 1.

A more practical example of the configuration shown in FIG. 6 is a configuration in which, when a communication module having a serial interface such as RS-232C is used, the interface connection unit 22 performs USB/serial conversion to allow the communication module to be connected to the system device 1 via the USB.

In the above embodiments, the ID information identifying the system device 1 and the ID information identifying the communication module 21 are compared in the system device 1 or in the communication module 2. In the example below, a check is made for a match in the ID information in the connection destination of the communication module 2.

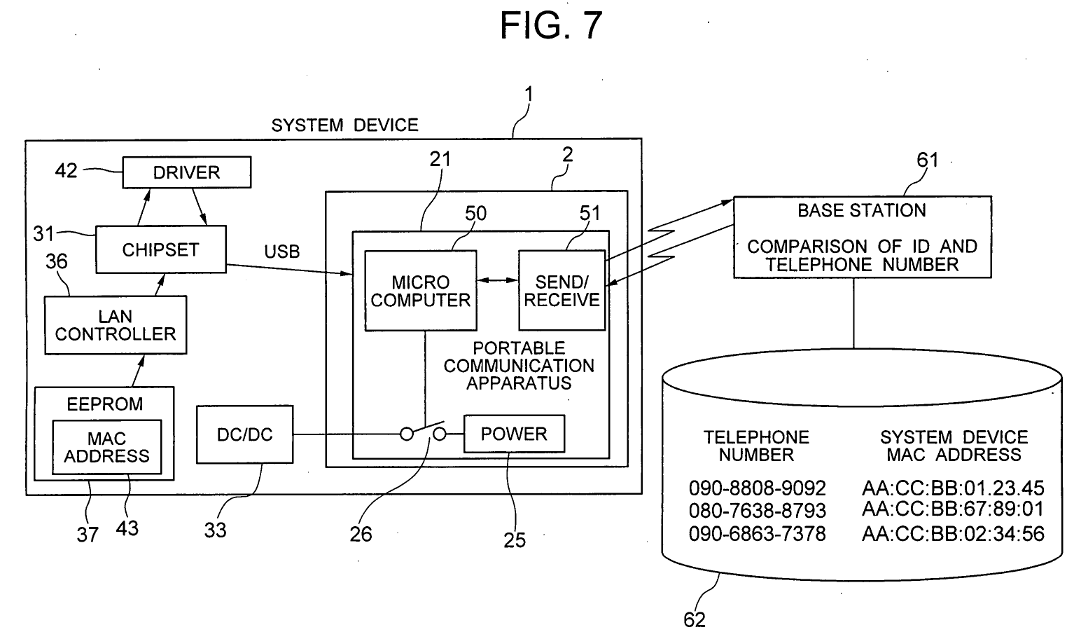

FIG. 7 is a diagram showing the general configuration of a system in which a wireless base station checks ID information. In FIG. 7, the communication system is assumed to perform mobile communication. The communication module 2 is wirelessly connected to a base station 61 of mobile communication, the base station 61 has a database 62 storing information on the mobile terminals capable of communicating with the base station, and the database 62 records the ID information on system devices each having the communication module 2 installed and each corresponding to a telephone number of connected mobile communication. The MAC address of a network installed on the system device 1 is registered in the database 62 as the ID information on the system device 1.

Referring to FIG. 7, the communication module 21 is installed in the expansion module 2 that is mounted on the system device 1. The communication module 21, connected to the system device via the USB, receives power from the DC/DC converter 33. The LAN controller 36 is installed in the system device 1, and the MAC address 43 of the LAN controller 36 is stored in the EEPROM 37.

When the communication module 21 is used for the first time, the driver 42 of the communication module 21 reads the MAC address 43 of the LAN controller 36 and notifies it to the communication module 21 via the USB. The communication module 21 notifies the notified MAC address of the system device 1 to the base station as the ID information on the system device 1. The base station 61 records the MAC address in the database 62 with the MAC address associated with the telephone number allocated to the communication module 21.

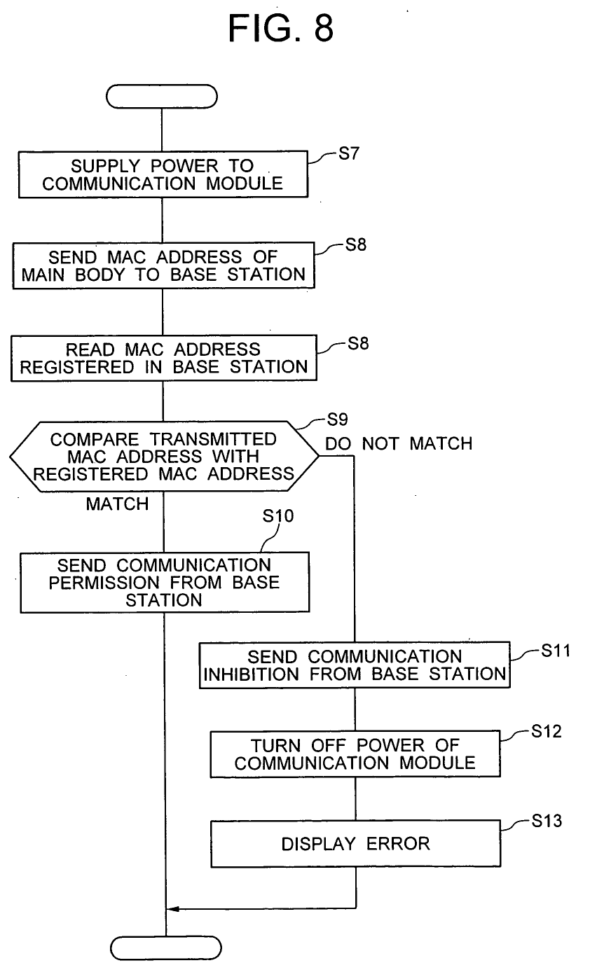

Next, referring to FIG. 8, the following describes the flow of the operation when the communication module 21 is used. When the system device 1 is started with the communication module 21 installed or the expansion module 2 is installed on the system device that is running, the power is supplied from the DC/DC 33 to the communication module 21 (step S7). When the communication module 21 starts communication with the base station 61 and becomes ready for communicate with the database 62, the communication module 21 receives from the driver 42 a notification indicating the MAC address 43 of the system device 1, on which the communication module 21 is currently mounted, and notifies the notified MAC address to the base station 61.

The base station 61 identifies the telephone number allocated to the communication module 21 in communication and reads the corresponding pre-stored MAC address of the system device 1 from the database 62 (step S9).

Next, the base station 61 compares the received MAC address of the system device 1 with the MAC address read from the database 62 (step S9). If both addresses are the same address, the base station 61 determines that an ID information match occurs and notifies a permission to communicate with the base station to the communication module 21 (step S10).

If the MAC addresses do not match in step S9, the base station 61 determines that a mismatch occurs in the ID information and sends a notification, which inhibits communication with the base station, to the communication module 21 (step S11). The communication module 21, which receives the communication inhibition notification, turns off the switch 26 to stop the power supplied from the DC/DC 33 to the communication module (step S12). In addition, upon detecting that the communication inhibition notification is sent from the base station 61 to the communication module 21, the system device 1 displays an error on the display, not shown, indicating that the communication module cannot be used (step S13).

As described above, the base station 61, to which the communication module 21 is connected, checks the ID information and the communication is carried out if matching ID information is registered in the database 62 in advance. Therefore, the communication is allowed only for a unique combination of the system device and the communication module.

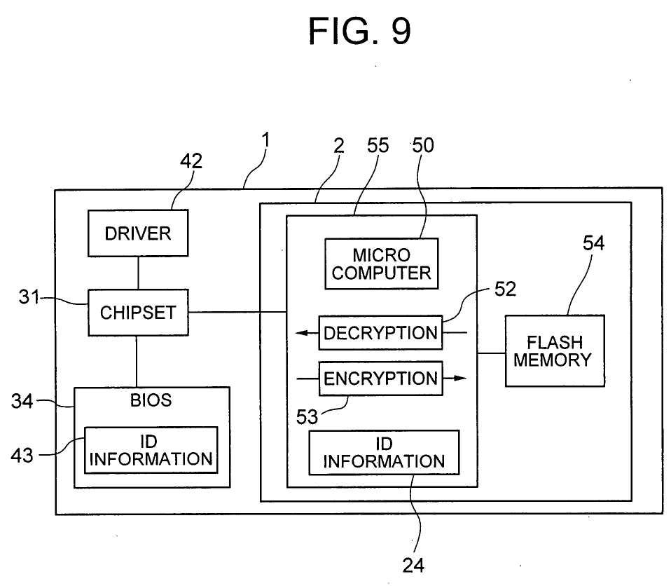

Although the embodiments of the present invention are described with a communication module as an example in the embodiments described above, the present invention is not limited to a communication module. The present invention can be applied also to a storage device in which a non-volatile memory such as a flash memory is installed. FIG. 9 is a diagram showing the general configuration of a system in which a flash memory 54 and a memory controller 55 are installed in the expansion module 2 that is connected to a system device 1 via the USB.

The system device 1 comprises a driver 42 that controls access to the expansion module, a chipset 31 that connects the expansion module 2, and a BIOS-ROM 31 in which the ID information 43, such as a manufacturing management number, for identifying the system device 1 is stored. The memory controller 55 comprises an encryption unit 53 that encrypts data instructed by the system device 1 to store, a decryption unit 52 that decrypts data, read from the flash memory 54, and notifies the decrypted data to the system device 1, an ID information recording unit 24 in which the ID information on the expansion module 2 is stored, and a micro computer 50 that controls those components.

When the expansion module is used for the first time, the driver 42 reads ID information 43 recorded in the BIOS 34 and notifies the ID information to the memory controller 55 via the USB of the chipset 31. The micro computer 50 of the memory controller 55 records the notified ID information in the ID information recording unit 24. When the system device 1 is started with the expansion module 2 installed or the expansion module 2 is installed in the system device that is running, the driver 42 reads the ID information 43 stored in the BIOS 34 and notifies the ID information to the memory controller 55 via the USB.

The micro computer 50, which receives the notification of the ID information 43 on the system device 1 from the driver 42, compares the notified ID information 43 with the ID information recorded in the ID information recording unit 24. Only if a match occurs in the ID information, the micro computer 50 responds to a read request/write request that will be issued from the driver. In response to a read request from the driver 42, the micro computer 50 reads data at the specified address from the flash memory 54, decrypts the data using the decryption unit 52, and sends the data to the driver 42 as the reply. In response to a write request from the driver 42, the micro computer 50 encrypts the specified data using the encryption unit 53 and writes the data in the flash memory 54. If a match does not occur in the ID information, a busy response is returned to a read/write request from the driver 42. When this response is returned, the access processing of the driver 42 times out and the driver 42 cannot read data.

In the above description, if a match occurs in the ID information, data from the driver is encrypted and stored in the flash memory 54, or encrypted data is read from the flash memory 54, decrypted, and returned to the driver as the response. Of course, the security of the flash memory 54 is ensured by checking the ID information.

Alternatively, the ID information recording unit 24 is configured to allow multiple pieces of ID information to be recorded therein, and a check is made to see if the ID information on the system device 1 notified from the driver 42 matches one of multiple pieces of stored ID information. This configuration has an effect of installing the expansion module on, or connecting the expansion module to, multiple system devices for shared use.

Although the embodiments of the present invention have been described, it is apparent that those skilled in the art may make various changes and modifications without departing from the spirit of the present invention and the scope of the appended claims.

1. An information processing system in which an expansion module, including devices such as a communication module, is built in, comprising:
a first ID recording unit in which ID information, which identifies said information processing system, is recorded;
a second ID recording unit in which a copy of the ID information in said first ID recording unit is recorded when said expansion module is initialized;
an ID comparison unit that compares the ID information recorded in said first ID recording unit with the ID information recorded in said second ID recording unit when said expansion module is used; and
a module control unit that controls whether said expansion module is to be operated according to the comparison result of said ID comparison unit,
wherein said module control unit makes said expansion module available for use if the ID information in said first ID recording unit matches the ID information in said second ID recording unit.

2. The information processing system according to claim 1 wherein
a main body of said information processing system includes said first ID recording unit and said ID comparison unit and
the expansion module of said information processing system includes said second ID recording unit and said module control unit.

3. The information processing system according to claim 2 wherein
said expansion module has a shape in which a CD-ROM/DVD drive is built in and
the communication module built in said expansion module has a standardized size.

4. The information processing system according to claim 2 wherein
said first ID recording unit is a ROM in which ID information uniquely identifying said information processing system, such as a manufacturing management number of said information processing system, is recorded and
said second ID recording unit is a write-once device or a write protected recording unit.

5. The information processing system according to claim 2
wherein, if the ID information in said first ID recording unit does not match the ID information in said second ID recording unit, said module control unit stops a supply of power to devices included in said expansion module.

6. The information processing system according to claim 1
wherein a main body of said information processing system includes said first ID recording unit and
the expansion module of said information processing system includes said second ID recording unit, said ID comparison unit, and said module control unit.

7. The information processing system according to claim 6
wherein, if said ID comparison unit finds that the ID information in said first ID recording unit does not match the ID information in said second ID recording unit as a result of the comparison, the module control unit stops a supply of power to the devices included in said expansion module and, at the same time, stops an interface function with the devices included in said expansion module.

8. The information processing system according to claim 6
wherein said module control unit comprises encryption means for encrypting data instructed by the main body of said information processing system to store and decryption means for decrypting a device included in said expansion module and notifying the decrypted result to the main body of said information processing system.

9. The information processing system according to claim 8
wherein, if said ID comparison unit finds that the ID information in said first ID recording unit does not match the ID information in said second ID recording unit as a result of the comparison, said module control unit sends a busy response to an access request from the main body of said information processing system.

10. An information processing system comprising a wireless base station and an information processing system main body, said information processing system main body including an expansion module that includes devices such as a communication module for communicating with said wireless base station, said information processing system comprising:
a first ID recording unit in which ID information for identifying said information processing system is recorded;
a second ID recording unit in which a copy of the ID information in said first ID recording unit is recorded for each piece of identification information on said communication module when said communication module is initialized;
an ID comparison unit that compares the ID information recorded in said first ID recording unit with the ID information recorded in said second ID recording unit when said expansion module is used; and
a module control unit that controls whether said expansion module is to be operated according to the comparison result of said ID comparison unit,
wherein said module control unit compares the ID information in said first ID recording unit with the ID information in said second ID recording unit for each piece of identification information on said communication module when said communication module is used and, if a match occurred in the ID information, makes said communication module available for use.

11. The information processing system according to claim 10
wherein said information processing system main body comprises said first ID recording unit and
said base station comprises said second ID recording unit, said ID comparison unit, and said module control unit.

12. The information processing system according to claim 11
wherein a MAC address of a LAN of said information processing system main body is recorded in said first ID recording unit and the MAC address is sent to said base station when said communication module is initialized and
the MAC address that is sent is recorded in said second ID recording unit for each telephone number of said communication module.

13. The information processing system according to claim 12
wherein the communication module of said information processing system main body sends the telephone number of said communication module and the MAC address of the LAN of said information processing system main body to said base station when the communication module communicates with the base station and
the module control unit of said base station calls the MAC address corresponding to the telephone number, sent from said communication module, from said second ID recording unit, compares the called MAC address with the MAC address sent from said communication module and, if a match occurs, notifies a communication permission from said base station to the communication module.

14. The information processing system according to claim 13
wherein the module control unit of said base station calls the MAC address corresponding to the telephone number, which is sent from said communication module, from said second ID recording unit, compares the called MAC address with the MAC address sent from said communication module and, if a mismatch occurs, notifies a communication inhibition from said base station to the communication module and
the communication module of said information processing system main body has a power supply stopped when the communication inhibition is received from said base station.

15. The information processing system according to claim 14 (terminal processing when an error occurs)
wherein, when the communication inhibition is received from said base station, said information processing system main body displays a message indicating that the communication module cannot be used.

16. A control method for an information processing system in which an expansion module, including devices such as a communication module, is built, said control method comprising the steps of:
reading ID information, which denitrifies said information processing system, from a first ID recording unit when said expansion module is initialized;
recording the ID information in a second ID recording unit;
comparing the ID information recorded in said first ID recording unit with the ID information recorded in said second ID recording unit when said expansion module is used; and
controlling whether or not said expansion module is used according to the comparison result of the ID information.

17. The control method for an information processing system according to claim 16, further comprising the step of
stopping a power supply to said expansion module if a mismatch occurs in the comparison result of the ID information.

18. The control method for an information processing system according to claim 16, further comprising the step of
stopping an interface function of said expansion module if a mismatch occurs in the comparison result of the ID information.

19. The control method for an information processing system according to claim 16, further comprising the step of
returning a busy response to a request to access said expansion module if a mismatch occurs in the comparison result of the ID information.

20. The control method for an information processing system according to claim 16, further comprising the step of
displaying a message indicating that said expansion module cannot be used if a mismatch occurs in the comparison result of the ID information.
